(19) United States
(12) Patent Application Publication
(10) Pub. No.: US 2022/0237476 A1
(43) Pub. Date: Jul. 28, 2022

(54) MACHINE LEARNING PREDICTIVE MODEL BASED ON ELECTRICITY LOAD SHAPES

(71) Applicant: ORACLE INTERNATIONAL CORPORATION, Redwood Shores, CA (US)

(72) Inventors: Oren BENJAMIN, Arlington, VA (US); Ben PACKER, Redwood City, CA (US); Justine KUNZ, San Francisco, CA (US); Erik SHILTS, San Francisco, CA (US)

(21) Appl. No.: 17/723,031

(22) Filed: Apr. 18, 2022

Related U.S. Application Data
(63) Continuation-in-part of application No. 15/886,083, filed on Feb. 1, 2018, now Pat. No. 11,308,563.

(51) Int. Cl. G06N 5/02; H02J 3/00

(52) U.S. Cl. CPC G06N 5/022; H02J 2203/20; H02J 3/003

(57) ABSTRACT

Systems, methods, and other embodiments associated with a machine learning predictive model for predicting a propensity to implement energy reduction settings are described. Data records including load data for a target group of dwellings is obtained. An empirical load shape is generated for each given target dwelling based on the load data. A target feature vector is generated for each given target dwelling based on at least the empirical load shape corresponding to the given target dwelling. A trained machine learning predictive model is executed on the target feature vectors of the target group of dwellings to identify a set of target dwellings that are likely to reduce electricity consumed in accordance with electricity settings based on at least a generated predicted propensity for a target dwelling to implement the electricity settings.

### CROSS REFERENCE TO RELATED APPLICATION

This disclosure claims the benefit of priority to U.S. patent application Ser. No. 15/886,083 (issued as U.S. Pat. No. 11,308,563), entitled “Energy Program Communication Control System and Method Based On Load Shape Analysis,” filed Feb. 1, 2018, assigned to the present assignee, which is incorporated herein by reference in its entirety for all purposes.

### BACKGROUND

An electrical power grid or system can experience a power outage when too much power is consumed and drawn from the electrical power grid. For example, during a peak event, power generators may have difficulty generating enough electricity and/or an overload condition may occur. This may result in blackouts, brownouts, and may even cause damage to electrical distribution equipment such as switches and transformers. In some conditions, one or more additional electric power generators are put online to generate more power.

Reducing resource consumption (e.g., usage of electricity) causes less power to be drawn from an electrical power grid. This in turn causes less power to be generated by the electrical power grid.

Utility companies and other entities offer a variety of energy efficiency programs that aim to motivate customers to consume energy more efficiently. Each such program will have different measures offered as incentives to the energy customers.

With so many programs available, and such a variety of different measures offered under those programs, utility companies lack a practical way to inform energy customers about the available programs. Further, utility companies have traditionally been unable to distinguish their energy customers who are likely to participate in certain energy-efficiency programs, from those who are unlikely to participate. Computer systems may permit data records for energy customers to be sorted, or grouped into classes based purely on generalized data identifying a type of structure that is identified in the data records for the energy customers. For example, energy customers can be grouped into a subgroup of customers that reside in a single family home and a subgroup of customers that reside in a multi-family apartment building. However, the propensity of customers within each such subgroup to participate in an energy efficiency program may vary widely.

As a result, conventional computer systems have been unable to filter data records within a general classification for energy customers who are likely to participate in an energy efficiency program from those who are unlikely to participate to control communications regarding such programs. Instead, information about all available programs has traditionally been sent via electronic or physical communication channels to all energy customers. Transmitting information about all programs to all energy customers wastes computational and network resources for electronically-transmitted information (e.g., email, push notifications, etc.). Transmitting information about all programs to all energy customers wastes natural resources for physically-transmitted information (e.g., via postal service, etc.). And regardless of the mode of transmission, inundating energy customers with information about inapplicable energy efficiency programs is likely to irritate those energy customers. Irritated energy customers may disregard all such information received in the future, even if the information pertains to programs for which those energy customers qualify.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 schematically illustrates an embodiment of an energy distribution network and a computing system for training a machine learning predictive model to predict participation in energy reduction.

FIG. 2 illustrates a flow diagram schematically depicting an embodiment of a method of a machine learning model trained for predicting a propensity of a target dwelling to participate in energy reduction.

FIG. 3 illustrates one embodiment of a method for predicting a propensity by a machine learning predictive model.

FIG. 4 illustrates an example computing device that is configured and/or programmed in accordance with one or more of the example systems and methods described herein.

### DETAILED DESCRIPTION

In one embodiment, a machine learning (ML) predictive model is described herein that is configured to make predictions based at least on electricity load shapes of power consumed at different locations/dwellings. The machine learning predictive model is trained with a training set of known data records from energy consuming locations (e.g., dwellings) that are known participants in implementing energy reductions or known non-participants in implementing energy reductions. The ML predictive model learns from load shapes and dwelling characteristics from the training set of known data records to predict whether an input data record (e.g., an input feature vector) from a target dwelling is likely to participate in implementing energy reduction settings or measures.

In another embodiment, computerized systems and methods are described herein that manipulate data records for energy consumption locations to identify and/or generate load shapes representing measured energy consumption patterns in the data records. Each identified load shape is matched to an established load shape that most accurately represents the energy consumption pattern in the respective data record. A machine learning predictive model is trained with a training set of known data records from energy consuming locations (e.g., dwellings) that are known participants in implementing energy reductions and known non-participants that do not implement energy reductions.

Application of the predictive model to an input set of data records results in a prediction for an input data record as being associated with an energy consuming location (e.g., dwelling) that is likely to participate in implementing energy reduction settings/measures including an energy efficiency program, or associated with an energy consuming location (e.g., dwelling) that is unlikely to participate. The prediction from the predictive model may then be used to select and target the transmission of information about energy reduction settings or energy efficiency programs to the target dwellings with at least a threshold propensity to participate.

Historically, utility companies have relied on manufacturers and retailers of energy saving appliances to offer products using energy efficiency as an incentive. Otherwise, utility companies have instituted their own informational campaigns using traditional approaches such as blanket mailing physical materials to all energy customers. However, such approaches have exhibited limited effectiveness and they waste resources by targeting too many customers with little or no chance of reducing energy consumption.

In an effort to address at least some of the above shortcomings, the present disclosure involves a computer-implemented technique and algorithm that includes supervised machine learning to “train” a machine learning (ML) predictive model. The trained ML predictive model seeks to distinguish between data records (including energy consumption patterns) associated with energy consuming dwellings (and its occupants) that have a propensity to participate in implementing energy reduction settings/measures/program and data records associated with energy consuming dwellings (and its occupants) that are unlikely to participate in implementing energy reduction settings/measures/program.

The predictive model is trained using a training set of data that includes collected data such as prior known participation data, available dwelling characteristics, demographic and/or site parcel data, and/or energy consumption data/patterns (e.g., load data and/or load shapes) measured with a smart meter or other meter for each dwelling in the training set. The training set includes data records from (1) dwellings that are known to have participated in implementing energy reductions or an energy efficiency program, and (2) dwellings that are known to have not participated in implementing energy reductions or an energy efficiency program.

In one embodiment, the energy reductions include, but are not limited to, adjusting energy consumption settings on a temperature control device to reduce energy consumption. This may include changing heating and/or cooling settings in a thermostat to reduce consumption of electricity or gas.

Relative proportions of the data records for dwellings known to have participated (participants), and for dwellings that are known to have not participated (non-participants) may be any proportion based on the collected data records. In general, at the time of this disclosure, the number of participants has been observed to be much smaller than the number of non-participants. This difference, thus, may be seen in the training set of data records. However, the data records in the training set may be adjusted to have approximately the same or similar proportions of participants and non-participants, in one embodiment.

Trained in this manner, the predictive model can be applied to data records for target dwellings not in the training set, and having an unknown propensity to participate in implementing energy reductions. Thus, the trained predictive model is configured to predict whether a target dwelling, which is a non-participant, is likely to participate in the future. In one embodiment, the prediction may be in the form of a propensity value that represents a degree of likelihood to participate. For example, the propensity values may be configured to fall within a likelihood range, for example, 0 (least likely) to 10 (most likely). Of course, other types of ranges may be used (e.g., 0 to 1, percentages, or other type of range).

In one embodiment, training involves developing a machine learning (ML) predictive model that distinguishes between energy consumption data records of dwellings that are likely to participate from energy consumption data records of dwellings that are unlikely to participate based, at least in part, on one or more of: an empirically-determined load shape (e.g., representing a consumption pattern) generated from actual measured load data from each dwelling; dwelling characteristics such as square footage, heat type (e.g., forced air, hot water, heat pump, etc.), the condition of the dwelling, etc.; demographic information of the dwelling occupants (energy customers); and a prior participation history of dwellings. In one embodiment, a selected portion of the data associated with each dwelling is used and converted into a feature vector for the corresponding dwelling.

In one embodiment, the empirical load shapes may be categorized into and/or replaced by a closest matching defined load shape out of a defined set of established load shapes. The predictive model is trained using the established load shapes, which becomes one variable of a feature vector for each dwelling in the training data set.

One or more additional variables such as dwelling characteristics associated with a dwelling, heat type, the condition of the dwelling, etc., may also be included in the feature vectors that are input to the predictive model to further discriminate between non-participants who are likely to participate and non-participants who are unlikely to participate.

Use of the load shape of dwellings to train the predictive model has shown significant predictive capacity and accuracy beyond that of other features that do not include load shapes.

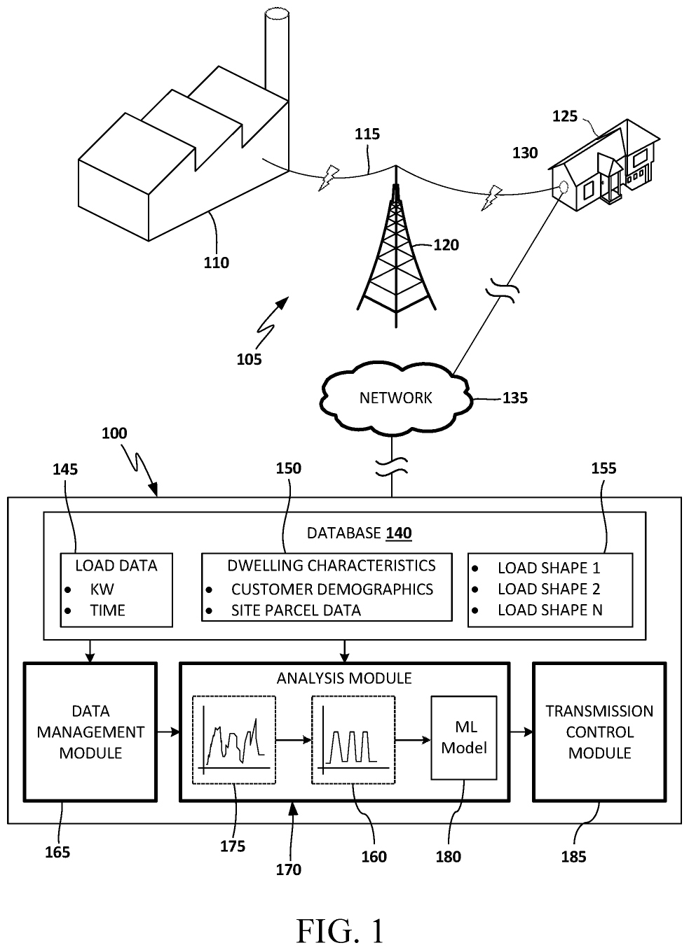

With reference to FIG. 1, an illustrative embodiment of a system 100 associated with analyzing data records for predicting energy customer participation in an energy efficiency program is illustrated. The system 100 is shown and described herein for use with an electric power distribution system 105 for the purpose of clearly describing the present technology. However, the system 100 can be utilized in association with any other utility or consumable product supplier such as a natural gas distribution system, for example.

The electric power distribution system 105 includes a station 110 that can be a generation station, substation, distribution point or any other supplier of electricity operated by, or on behalf of an electric utility. A network including transmission lines 115 supported by one or more towers 120 conducts electricity between the station 110 and a dwelling 125 associated with an energy customer. The network can include other transmission and distributions devices such as transformers, switches, etc., but such devices have been omitted from FIG. 1 for the sake of clarity.

As used herein, the dwelling 125 refers to and represents any location that consumes an energy resource (e.g., electricity, gas, water, etc.) where the consumption is measured separately from other locations by some type of meter. The dwelling includes, but is not limited to, a single-family residential home, any single-family or multi-family residential home, condominium, apartment, etc.; a commercial office or building; a retail store; an industrial plant; a government building; or any other structure that is associated with energy consumption and supplied with one or more energy resources.

In one embodiment, the dwelling 125 is equipped with a meter 130 that measures a quantity of electric power consumed by the dwelling 125 over a time period. The measured quantity of power consumed in a time period is referred to as load data. Other types of meters may also be connected for measuring other resources like gas and water consumed at the dwelling. These types of measured consumption data may also be used as load data, in one embodiment.

An embodiment of the meter 130 includes a “smart meter.” A smart meter includes a network communication module (not shown) that, at a defined interval such as monthly, quarterly, etc., or upon a control request, transmits data collected by the meter over a communication network 135. The communication network 135 can include a wide area network (“WAN”) such as the Internet, a local area network (“LAN”) including residential or local networking devices such as wireless routers and switches, a modem, etc., or a combination of a WAN and a LAN.

The transmitted data associated with the dwelling 125 represents an actual measured quantity of power consumed at the dwelling 125 over a time period. The measured quantity of power consumed is the load data 145 for a corresponding dwelling. The transmitted data can also be stored in a database 140 that is accessible by the system 100. Data transmitted by the smart meter includes, but is not limited to a portion of, and the load data 145 that is indicative of a quantity of electric power consumed at the dwelling 125 at different times. For example, the data transmitted by the smart meter can include data that expressly identifies, or data that can be used to determine, the total power consumed during a week, day, hour, etc.; the length of time over which power consumption is reported such as a month, quarter, etc.; kilowatt-hours; and the like.

For embodiments of the meter 130 that may lack the ability to transmit the data over the communication network 135, the data that would be transmitted via the communication network 135 by a smart meter can be manually read and recorded in the database 140. Whether the data is transmitted over the communication network 135 or manually recorded in the database 140, the data can be associated with data records corresponding to each different dwelling (e.g., an energy consumer).

In one embodiment, the system 100 is a computing system including an application or collection of distributed applications for enterprise organizations. The applications and computing system 100 may be configured to operate with or be implemented as a cloud-based networking system, a software as a service (SaaS) architecture, or other type of networked computing solution. In one embodiment the system 100 is a centralized server-side application that provides at least the functions disclosed herein and that is accessed by many users via computing devices/terminals communicating with the system 100 (functioning as the server) over a computer/communication network 135.

In one embodiment, one or more of the components described herein are configured as program modules stored in at least one non-transitory computer readable medium. The program modules are configured with stored instructions that when executed by at least a processor cause the computing device to perform the corresponding function(s) and methods as described herein.

The system 100 of FIG. 1 includes the database 140 that stores at least a portion of the data used by the system 100 as described herein. The database 140 can reside on a non-transitory computer-readable medium, or include data that is stored by a non-transitory computer-readable medium array, made up of a plurality of storage devices. According to yet other embodiments, the information included in the database 145 described with reference to the illustrated embodiment can be acquired from a plurality of different databases. Further, any portion of the data included in the database 140 and utilized by the system 100 may be acquired from a remote database that is external to the system 100 and does not form a portion of the system 100. Such an external database can be accessible by the system 100 via the communication network 135 or a local data communication link.

For the sake of brevity, the database 140 shown in FIG. 1 is described herein as including the data utilized as factors/variable by the system 100 to predict a propensity of a target dwelling to participate in implementing energy reduction settings/measures, which may include an energy efficiency program. Such a prediction is achieved by training a machine learning predictive model and applying the trained predictive model to target data records associated with energy consumers/dwellings/locations.

Among the data in the database 140 included in a data record of a corresponding dwelling is the load data 145 of a dwelling. The load data 145 is indicative of electric power consumed at the corresponding dwelling, at different times. The load data 145 can be utilized by the system 100 to determine the total power consumed at the corresponding dwelling 125, in kilowatt-hours on a daily basis, for example, for each of a plurality of different days within a period of time (e.g., over a monthly period, a three-month period, etc.). The load data for each dwelling is used to generate an empirical load shape for the dwelling that represents a graphic consumption pattern of the dwelling over a time period.

The database 140 may also include dwelling characteristics 150 that are specific to each dwelling 125 and/or an energy customer associated with the data record of the corresponding dwelling. For example, in one embodiment, the dwelling characteristics 150 can include one or more of, or combinations of, the following types of data that may be part of data records corresponding to a dwelling:
Demographic data of dwelling occupants. For instance, the demographic data can include a number of adults residing in the dwelling, the number of children residing in the dwelling, whether the energy customer owns or rents the dwelling, etc.
Site parcel data or other data describing features of the dwelling. For example, the site parcel data can include a square footage of the dwelling, the number of floors, or other indication about the size of the dwelling. A type of heat (e.g., electric, gas, fuel oil, wood, etc.) used to heat the dwelling during cold seasons, a dwelling type (e.g., single family home, multi-family apartment complex, etc.) can also be included in the site parcel data.
Miscellaneous data may also be useful in predicting dwelling's propensity to participate in energy reduction measures or energy efficiency program could also be included in the dwelling characteristics 150. For example, the number of other participating programs and/or measures implemented in the dwelling to reduce consumption may be stored as dwelling characteristics 150 in the database 140. The historical participation (or lack thereof) of the dwelling in energy reduction setting/measures or efficiency programs may a useful indicator of whether a dwelling (and its occupants) is generally receptive to such programs and/or measures.

The load data 145 is the total electrical power used by a dwelling for a given time (e.g., in real-time, for a specific hour, for a day, etc.). The electric load changes with time in response to changes in the operation of electric devices such as lights, heating, ventilating, air conditioning equipment, computer and office equipment, furnaces, and other industrial equipment, etc. The electric load may be represented by measured data that defines a graphical curve, other line graph, plot or other graphical representation as a function of time.

The graphical curve represents an “empirical load shape,” and graphically reveals a load pattern that captures or represents the daily energy usage pattern of a dwelling. As used herein, the “empirical load shape” of a dwelling is generated from and represents the actual measured load data from the dwelling.

In one embodiment, a library 155 comprising a plurality of established load shapes is also included in the database 140. For example, the “established” load shapes may be a small number of archetypal patterns that categorize, capture or represent the most common daily energy usage patterns. In one embodiment, the most common archetypal patterns are a small subset of load shape categories, and may be identified and established using unsupervised learning from large smart-meter datasets that were previously collected. The smart-meter datasets may include advanced metering infrastructure (AMI) data of residential and/or commercial areas and include historically measured consumption patterns.

The established load shapes may be defined from N most-commonly occurring load shapes that are observed. The number N may be, for example, a small number such as four or five. However, N can be any positive integer value greater than one (1) (e.g., N can equal 2, 3, 4, 5, 6, 7, 8, etc.). In general, each established load shape is a general category of consumption patterns and load shapes. As described below, the empirical load shapes of dwellings are categorized into and/or replaced by a closest matching established load shape.

Using a small number of established load shapes simplifies the training of the ML model and reduces the computing resources needed to process the training set of data records. This is effectively a feature engineering step to compress each dwelling's high dimensional AMI data into a single categorical feature value. As such, the AMI data, which may represent hundreds of thousands of unique empirical load shapes from individual dwellings, is simplified into a small set of established load shape categories. To train directly on AMI data would involve more computing resources and a more complex model.

In another embodiment, if computing resources are not an issue, the actual empirical load shapes from the dwellings may be used. Using the actual empirical load shapes would thus represent a very large variety of different load shapes and consumption patterns due to the high dimensional nature of the AMI data. This causes the ML predictive model to become more complex as compared to using a limited set of established load shapes, but would result in a more accurately trained ML predictive model.

As stated above, the established load shapes include a generic or general representation of the N most-commonly occurring load shapes in a selected time period (e.g., daily load shapes). Each dwelling's empirical load shape is categorized and matched into one of the established load shapes. Thus, the predictive model uses the closest-matching established load shape as one variable for defining feature vectors for the training set of data records, as will be further described below.

In one embodiment, each established load shape in the library 155 is a data structure that defines a generalized representation of a load shape that is expected to be exhibited (e.g., based on prior observed meter data). Being a generalized representation, the established load shapes may not accurately reflect any specific empirical load shape, which are created based on actual electric power consumption data such as load data 145. Instead, the established load shape can be of a form that shows a general category of an ideal load shape having a smoothed pattern exhibiting characteristics distinctive of the power consumption patterns of different types of dwellings.

For example, one type of established load shape may represent a regular, repeating daily load shape 160 (as shown in FIG. 1) having equally-spaced rectangular peaks. This consumption pattern may be indicative of an office building that is closed on weekends. Electric power consumption is generally uniform at a high level during the work week (e.g., Monday-Friday), hence the rectangular peaks. On weekends, when the office building is closed, electric power consumption is generally uniform at a low level, forming the troughs between the rectangular peaks. Thus, the established load shape 160 can be a category of load shapes associated with dwellings 125, such as office buildings and schools, for example, that are closed on weekends but used during regular hours during the week.

Conversely, a second type of established load shape, which represents consumption patterns for a residential house, may be the inverse shape of the established load shape 160 for office buildings. For example, a residential house may have two adults who work regular business hours during the day (e.g., 8:00 AM-5:00 PM) and are not at home. During the work weeks (Mondays-Fridays), the consumed electric power is generally uniform at a low level while the house is vacant, resulting in troughs for workdays. On weekends, when the resident adults may be home longer during the day, electric power consumption is generally uniform at a high level, forming rectangular peaks for weekend days between the troughs. Different established load shapes can be included in the library 155 to represent other common load shapes or categories of archetypal patterns.

Although the embodiment of the load shape 160 is described as a weekly load shape, the present disclosure is not so limited. Another embodiment of the load shape 160 is a daily load shape. Instead of a curve of power consumed versus time (e.g., sampled at a daily frequency) over the course of a week, the daily load shape is a curve of power consumed versus time over the course of a twenty four (24) hour day. Thus, the sampling frequency of a daily load curve can be much higher than one sample recorded every day. For example, the daily load shape can be shown as power consumed on a scale of seconds, minutes or hours.

Further, the daily empirical load shape of a dwelling can be compared to established load shapes having patterns specific to weekdays, specific to weekends, and based on overall use depending on the day for which the empirical load shape is generated. For example, an empirical load shape for a weekday can be compared to established load shapes specific to weekdays. Likewise, an empirical load shape for power consumed during a weekend day can be compared to an established load shape specific to a weekend day.

To ensure the availability of a sufficient sample size of data used to train the ML predictive model 180 but not too large, the number of established load shapes in the library 155 can be limited. For instance, the number can be limited to a number that is less than a number of all known load shapes. In one embodiment, the library 155 can be limited to include N of the most-commonly occurring load shapes, where N can be any positive integer value greater than one (1) (e.g., N can equal 2, 3, 4, 5, 6, 7, 8, etc.). Each established load shape may be associated with a type of day (e.g., weekday, weekend, etc.), a category of week (e.g., season, holiday, etc.).

In one embodiment, the system 100 also includes a data management module 165. The data management module 165 serves as an interface with the database 140. At least load data 145 corresponding to the energy customer can be obtained from the database 140 by the data management module 165. However, other information such as the dwelling characteristics 150 and/or an established load shape in the library 155 can also be obtained by the data management module as described herein.

An analysis module 170 uses data obtained by the data management module 165, including the load data 145 for the energy customer, to determine and generate an empirical load shape 175 for each dwelling in the training dataset based on the obtained load data 145 corresponding to the dwelling. The empirical load shape 175 represents the pattern of actual power consumption by the dwelling over a period of time, as measured by the meter 130. As one example, the empirical load shape 175 can represent the daily power consumption at the dwelling 125 associated with an energy customer over the course of a month.

As stated previously, using the empirical load shapes from all the dwellings in the training data set involves a very large number of different shapes. To simply training, the empirical load shape of a dwelling may be replaced with one of the established load shapes when generating a feature vector for the dwelling.

In one embodiment, the empirical load shape of a dwelling is compared to the defined established load shapes in the library 155, based on similar time periods, to find a most closely matching established load shape.

The analysis module 170 then identifies an established load shape from the set of established load shapes, such as established load shape 160 in FIG. 1 for example, in the library 155 that most closely matches the empirical load shape 175 of a dwelling. The established load shape 160 that is the closest match is selected by the analysis module 170 and is used as a variable in the feature vector for the dwelling rather than the actual empirical load shape, which is used to train the ML predictive model 180. This is performed for all the data records in the training dataset.

In one embodiment, the ML predictive model 180 may be trained using feature vectors associated with each data record of a dwelling in the training dataset. Each feature vector is generated from selected characteristics data from a data record and includes at least the established load shape and one or more dwelling characteristics as previously defined. In one embodiment, the selected data is converted into numerical features that represent the data record of the dwelling. Thus, in one embodiment, each feature vector for a dwelling is an n-dimensional vector of the corresponding numerical features that describes the selected characteristics of the corresponding dwelling.

Each feature vector is assigned or associated with a binary label (e.g., participation value) indicating whether or not the respective dwelling is a participant or a non-participant in implementing energy reduction settings/measures/program. Since the training dataset is collected, it is known whether each dwelling is a known participant or a known non-participant. The ML predictive model is trained using the feature vectors and their known participation value to predict whether an input feature vector (from a target dwelling) is likely to participate in implementing energy reduction settings/measures/program.

In one embodiment, a logistic regression analysis can be performed using the feature vectors for each of the dwellings to develop a logistic regression model or other suitable algorithm as the predictive model. For example, the trained predictive model can be a binary classifier that classifies or otherwise makes a prediction that a target dwelling belongs into one of two classes: (i) a class of dwellings that are likely to participate in implementing energy reduction settings/measures/program, or (ii) a class of dwellings that are unlikely to participate in implementing energy reduction settings/measures/program. The ML predictive model 180 may also generate/predict a propensity value for each target dwelling that represents the dwelling's propensity or likelihood to participate. In one embodiment, the ML predictive model 180 may be configured to predict propensity values that fall within a likelihood range, for example, 0 (least likely) to 10 (most likely). Of course, other types of ranges may be used (e.g., 0 to 1, percentages, etc.).

Regardless of the type of predictive model, any scalar values, error constants, formula structure, etc. of the predictive model should distinguish between the feature vectors having the different participation binary labels with a reasonable degree of accuracy. Accordingly in one embodiment, the predictive model can be trained to be a function of the load shape associated to a dwelling's energy consumption (either the actual empirical load shape or the matched established load shape), and at least one other input variable of dwelling characteristics such as information about the dwelling, demographic data, heat type, dwelling condition, etc. associated with the energy customer. The input variables selected are used to form the feature vectors from the data records of the dwellings.

After the initial training, the ML predictive model 180 is complete, testing and continued refinement may be performed. As predictions are made for target dwellings using the trained predictive model, scalar values, error constants, or even the structure of the predictive model can be modified from the result of initial training. The predictions resulting from testing and use of the predictive model as well as data indicating whether a target dwelling (and its occupant/energy customer) ultimately elected to participate in reduction settings or energy efficiency program can be used to determine the accuracy of the predictions and to update the predictive model.

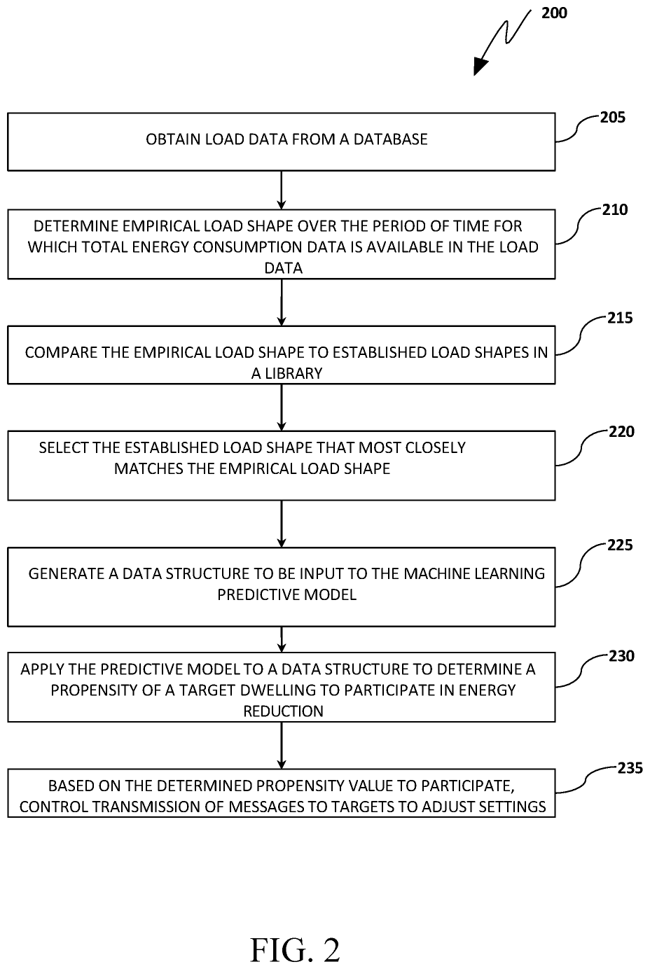

The trained model may then be used on a target set of non-participating customers/dwellings to predict which customers/dwellings are most likely to participate in implementing energy reduction settings/measures/program. For example, the analysis module 170 generates a data structure (e.g., a feature vector) for an input target dwelling to predict that dwelling's propensity to participate. In one embodiment, the feature vector of the input target dwelling should be created in the same manner as the feature vectors used for training the predictive model 180. The operation of the predictive model is described in more detail with reference to FIG. 2.

In general, the generated data structure may be a feature vector, in one embodiment, that includes at least the load shape (empirical or established load shape) associated with a target dwelling, and one or more dwelling characteristics such as demographic data and/or site parcel data corresponding to the target dwelling. The trained predictive algorithm of the ML model 180 is applied to the feature vector (data structure) to determine the propensity of the target dwelling to participate in implementing energy reduction settings/energy efficiency program. The prediction result (the propensity value to participate) can be embodied in a data structure output by the ML predictive model 180 and or associated with the target dwelling.

In one embodiment, the system 100 may update or otherwise modify the database 140 to tag a data record associated with the target dwelling/energy customer with its predicted propensity value and/or a predicted classification tag (a binary value: likely or unlikely to participate). The predictions for a group of target dwellings may then be used to identify the target dwellings (that are currently non-participants) that are most likely to participate based on their associated propensity value.

In one embodiment, the system 100 includes a transmission control module 185 configured to receive or retrieve the prediction results from the ML predictive model 180 and, based on the prediction results, control transmission of information about energy reduction settings and/or an energy efficiency program to the identified group of target dwellings that are most likely to participate, while eliminating the other target dwellings with lower propensity values. For example, if the prediction result indicates that a first target dwelling is more likely to participate in an energy efficiency program than a second target dwelling, the transmission control module 185 can designate the first target dwelling as a recipient of the energy reduction information and remove the second target dwelling from receiving communications. The updated record with this designation can subsequently be identified by searching the data records for the classification tag or propensity value. The identified data records with the classification tag are thus identified as recipients to whom an electronic message including the information about the energy reduction settings/program should be transmitted.

An electronic transmission of the electronic message can be addressed to an email address, a phone number at which a text can be received, or other electronic contact information associated with a target dwelling/location and/or occupants/owners of the target dwelling. This electronic transmission can then be transmitted via the communication network 35 based on a designed address of a recipient associated with the target dwelling. In one embodiment, the electronic message may include instructions to cause adjustments to heating or cooling settings on a temperature control device.

According to other embodiments, the system 100 may be configured to generate a physical message, for example, a letter, brochure, or other physical correspondence to include information about energy reduction settings, reduction measures, and/or energy efficiency program for target dwellings that have at least a threshold propensity value to participate. The physical message may then be transmitted to a physical transportation service for delivery.

According to other embodiments, in response to an energy customer logging into an online account with a utility company, the system 100 may be configured to access the data record of the associated dwelling of the customer to determine if the data record has been classified as likely to participate in energy reduction settings. If the data record has been classified as likely to participate, the system may select and transmit (via network communications) energy reduction information to be displayed on a display screen of the remote device of the energy customer.

Regardless of the manner of transmission, the transmission of such information to target dwellings (or energy customers) that are likely to participate can be prioritized over the transmission of such information to other target dwellings that were identified as not likely to participate as determined by the predictive model. Some target dwellings may have had a predicted propensity to participate in the energy efficiency program that was lower than a threshold value, or at least lower than the predicted propensity of a top group of most likely to participate target dwellings (e.g., top 10%, top 20%, top 50% of the highest propensity values). The target dwellings that have a predicted propensity value that is below the defined threshold are not sent communications regarding the energy reduction settings. This reduces an amount of network communications sent over a network and lowers the use of computing resources associated with generating and transmitting electronic communications.

Operation of the ML Predictive Model

With reference to FIG. 2, one embodiment of a flow diagram illustrates a method 200 of predicting a propensity of a target dwelling to participate in energy reductions/efficiency program using the predictive system 100. Method 200 is described in relation to having a set of target dwellings which are known non-participants or have an unknown participation status. The ML predictive model 180 is applied to the target dwellings to make a participation prediction for one or more of the target dwellings that are input to the predictive model.

Method 200 is also described with reference to the predictive model being trained using established load shapes, rather than using actual empirical load shapes from dwellings. Using empirical load shapes is described in another embodiment.

At block 205, in response to the system 100 receiving a request to predict the propensity of a target dwelling, the data management module 165 accesses the database 140 and obtains load data corresponding to the target dwelling. The load data identifies or can be used to determine the empirical load shape on a daily basis, for example.

At block 210, with the load data obtained by the data management module 165, the analysis module 170 determines/generates an empirical load shape for the defined period (e.g., daily). As previously described, the empirical load shape represents the power consumed at the target dwelling over the period of time. As noted above, the period of time can be one day, one week, a two week period, one month or another desired period. The period of time used should match the same period of time used in the training set of data.

At block 215, the analysis module 170 compares the determined empirical load shape to the established load shapes in the library 155. The analysis module 170 selects the established load shape that most closely matches the empirical load shape at block 220. For example, data values from the empirical load shape are compared to data values from one of the established load shapes (and repeated for the other established load shapes) and a matching function is based at least on a threshold value of difference in the values, based on any distance metric such as Euclidian distance, etc. The selected established load shape is then used in place of the actual empirical load shape.

At block 225, a data structure such as a feature vector for the target dwelling is generated. The generated data structure (target feature vector) should be generated as the same sized n-dimensional vector of numerical features with the same input variables as the feature vectors used in training the predictive ML model. The target feature vector (of the target dwelling) includes numerical values for parameters such as the established load shape that most closely matches the empirical load shape associated with the target dwelling, and one or more dwelling characteristics, demographic data and/or site parcel data. The target feature vector of the target dwelling forms the input to the trained predictive model.

At block 230, the trained predictive model is applied to the target feature vector to predict a likelihood (e.g., a propensity value) that the target dwelling will participate in implementing energy reduction settings or otherwise likely to reduce the electricity consumed within the target dwelling. In one embodiment, based upon the training of the predictive model, the predictive model may at least compare statistical similarities between the numerical features/parameters in the target feature vector including the established load shape to the feature vectors created from the training set of data from known participants and known non-participants.

The trained predictive model then generates a propensity value that represents the likelihood that the target dwelling will participate in implementing energy reduction settings/program. The propensity value may be configured to fall within a range of values as previously described that represent a low propensity to a high propensity. In another embodiment, the prediction may be a classification as either likely to participate or unlikely to participate.

In one embodiment, if a plurality of target dwellings is analyzed, the method 200 is repeated for each of the target dwellings.

According to alternate embodiments, the predicted propensity value of the target dwelling may be compared to a threshold value that separates a likely participant from an unlikely participant. The predicted propensity values may also be presented on a display device to a user to be compared by the user to determine the relative propensity values between multiple target dwellings.

In one embodiment, the predicted propensity values from the ML predictive model for the group of target dwellings may be used to rank and/or filter the target dwellings (which are known non-participants or have an unknown participation status) according to the predicted propensity. A selected group of target dwellings may be identified that have the highest propensity to participate based at least in part on a threshold propensity value. The selected group of target dwellings is then used to control subsequent communications.

At block 235, based on the selected group of target dwellings, the transmission control module 185 transmits, modifies or generates data that controls transmission of electronic message and/or a physical message including information about reduction settings/energy efficiency program. As stated previously, the message may be transmitted electronically via a network communication to an address associated with each of the selected group of target dwellings most likely to participate. For example, the transmission control module 185 can prioritize a transmission of messages and information to selected target dwellings.

Thus, targeted communications are established based on the ML predictive model, which reduces computing resources, network transmissions, and physical resources by only transmitting to a smaller set of recipients.

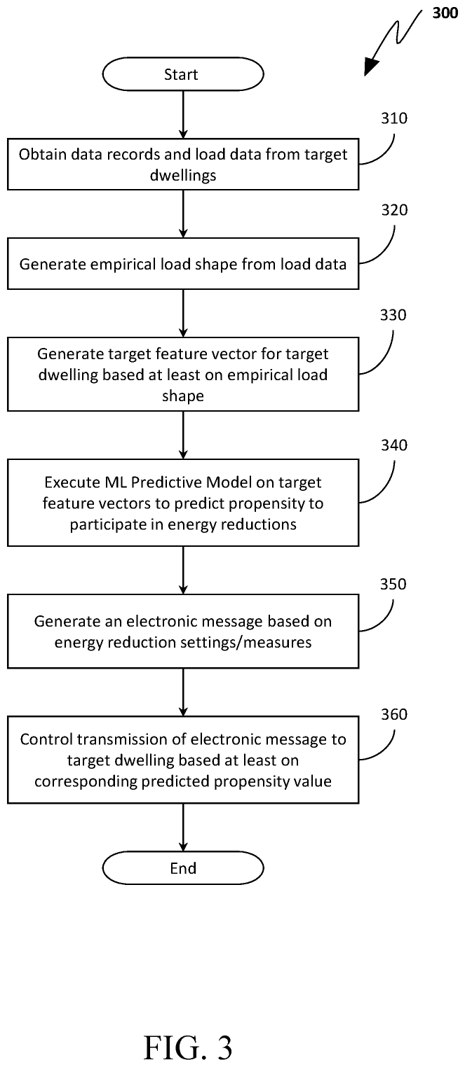

With reference to FIG. 3, one embodiment of a method 300 is shown that is associated with the present system 100 and the ML predictive model predicting a propensity to participate for one or more target dwellings. Method 300 is described in relation to having a set of target dwellings which are known non-participants or have an unknown participation status. The ML predictive model 180 is applied to the target dwellings to make a participation prediction for one or more of the target dwellings that are input to the predictive model.

Method 300 is also described with reference to the predictive model that is trained using feature vectors generated with actual empirical load shapes from dwellings in the training dataset and at least one dwelling characteristic.

At block 310, the system obtains, from a database via network communications, data records including load data that corresponds to one of the target dwellings, or may retrieve multiple data records at a time for a target group of dwellings. As previously described, the load data for a given target dwelling is indicative of electricity consumed by the given target dwelling over a specified period of time.

At block 320, an empirical load shape is generated, by at least a processor of the system, for each given target dwelling based on the load data from the given target dwelling.

At block 330, a target feature vector is generated for each given target dwelling using at least the empirical load shape from the corresponding given target dwelling. In one embodiment, the generated target feature vector should be generated as the same sized n-dimensional vector of numerical features with the same input variables as the feature vectors used in training the ML predictive model.

At block 340, the machine learning (ML) predictive model is executed on the target feature vectors of the target group of dwellings to generate a prediction and identify a set of target dwellings that are likely to reduce the electricity consumed in accordance with at least adjusting electricity settings. In one embodiment, the ML predictive model generates the prediction by, for example:

(i) inputting the target feature vector of each given target dwelling into the machine learning predictive model; and

(ii) generating, by the machine learning predictive model, a predicted propensity value to implement the electricity settings for each given target dwelling based on a classification of at least the target feature vector, which includes the empirical load shape, to one or more empirical load shapes in the machine learning predictive model that are associated with reducing electricity based on the electricity settings. The predictive propensity value represents the propensity of a target dwelling to participate as previously described. It is noted that a feature vector that includes the empirical load shape means a numerical feature representation of the empirical load shape and not an actual graphical load shape, although it may in other embodiments.

At block 350, after one or more propensity values are predicted for one or more target dwellings, an electronic message may be generated including the electricity settings and/or other selected content relating to energy reduction measures or program as previously described. In one embodiment, the electronic message includes instructions to cause adjustments to heating and/or cooling temperature settings on a temperature control device.

At block 360, the processor may control a transmission of the electronic message to an electronic address associated with one or more of the target dwellings who are likely to participate and implement the electricity settings based on their predicted propensity value. In one embodiment, target dwellings that have a predicted propensity value above a threshold value (representing a higher degree and likelihood to participate) are selected as recipients for transmission of the electronic message. Other target dwellings (less likely to participate) are filtered out and do not receive the electronic message. Thus, targeted communications are established based on the ML predictive model, which reduces computing resources, network transmissions, and physical resources by only transmitting to a smaller set of recipients.

In another embodiment, method 300 may be implemented where the ML predictive model is trained using a set of established load shapes rather than empirical load shapes. This was described previously and may be implemented in method 300. As such, the predictions are made based on matching established load shapes to empirical load shapes of target dwellings. As previously described, replacing empirical load shapes with a matching established load shape from a limited set of defined established load shapes simplifies the complexity of the ML predictive model.

In another embodiment of method 300, the ML predictive model may be trained and operated as follows.

Prior to block 310, the ML predictive model may be trained by inputting a training set of data to the ML predictive model. The training set of data includes data records from a plurality of dwellings, wherein a data record for a corresponding dwelling includes at least (i) a load shape based on power consumed by the corresponding dwelling over a time period, and (ii) participation data that indicates that the corresponding dwelling is a known participant in energy reduction settings or is a known non-participant in the energy reduction settings.

A feature vector is generated for each of the data records from the training set of data and includes a number of input features. In one embodiment, the feature vector for a corresponding dwelling including input features that represent at least the load shape and a dwelling characteristic of the corresponding dwelling. The load shape may be an empirical load shape, which may be directly used, or may be replace with an established load shape as previously described.

A binary label is assigned to each of the feature vectors indicating whether the corresponding feature vector represents a known participant in the energy reduction settings or a known non-participant. As stated, the training data set is from known dwellings and it is known whether each dwelling is a participant or known non-participant (e.g., known participation status).

The machine learning predictive model is then trained based at least in part on the feature vectors of the known dwellings to classify target dwellings into (i) a class of dwellings that are likely to participate in implementing the energy reduction settings, or (ii) a class of dwellings that are unlikely to participate in implementing the energy reduction settings.

In response to a request to predict a propensity to implement or participate in the energy reduction settings for a target group of dwellings that are known to be non-participants (which may include unknown participant status) in implementing the energy reduction settings:

Generate an empirical load shape for each given target dwelling based on load data from the given target dwelling (block 320). A target feature vector for each given target dwelling is generated using at least the empirical load shape of the given target dwelling (block 330).

The machine learning predictive model is executed (block 340) and applied to the target feature vectors of the target group of dwellings to identify a set of non-participants that are likely to implement the energy reduction settings. This, for example, includes:

(i) inputting the target feature vector of each given target dwelling into the machine learning predictive model; and

(ii) generating, by the machine learning predictive model, a predicted propensity to participate in implementing the energy reduction settings for each given target dwelling. The predicted propensity is at least based on a classification of at least the target feature vector, which was created with the empirical load shape, to one or more load shapes in the training set of data. In one embodiment, this may include generating statistical similarities of the target feature vector to the known feature vectors from the training dataset and their corresponding participation status.

An electronic message may be generated including content or instruction about implementing one or more energy reduction settings or other program (block 350) as previously described. In one embodiment, the electronic message includes instructions to cause adjustments to heating or cooling temperature settings on a temperature control device associated with the target dwelling.

Transmission of the electronic message may then be controlled by the processor to select and transmit to an electronic address associated with one or more of the target dwellings who are likely to participate based on the predicted propensity (block 360) as previously described.

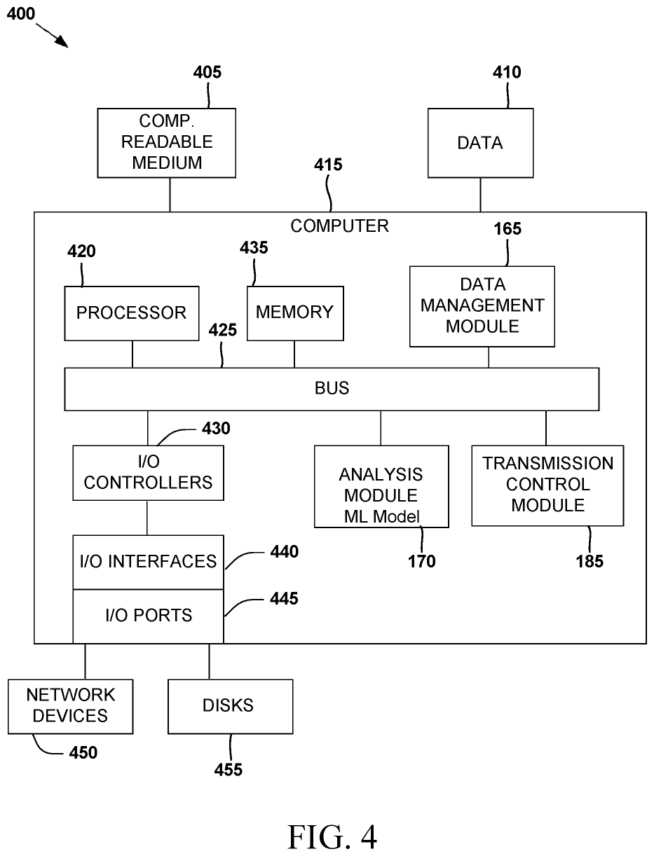

FIG. 4 illustrates an example of a computing device 400 that is configured and/or programmed with one or more of the example systems and methods described herein, and/or equivalents. The illustrative example of a computing device 400 may be a computer 415 that includes a processor 420, a memory 435, and I/O ports 445 operably connected by a bus 425. In one embodiment, the computer 415 may include logic of the data management module 165, the analysis module 170 including the ML predictive model 180, and the transmission control module 185, configured to facilitate the system 100 and/or the method described with respect to FIGS. 1, 2, and/or 3. In different embodiments, the logic of the data management module 165, the analysis module 170, and the transmission control module 185 may be implemented in hardware, a non-transitory computer-readable medium 405 with stored instructions, firmware, and/or combinations thereof. While the logic of the data management module 165, the analysis module 170, and the transmission control module 185 is illustrated as a hardware component attached to the bus 425, it is to be appreciated that in other embodiments, the logic of one or more of these modules could be implemented in the processor 420, stored in memory 435, or stored in disk 455.

In one embodiment, logic of the data management module 165, the analysis module 170, and the transmission control module 185, or the computer 415 is a means (e.g., structure: hardware, non-transitory computer-readable medium, firmware) for performing the actions described. In some embodiments, the computing device 400 may be a server operating in a cloud computing system, a server configured in a Software as a Service (SaaS) architecture, a smart phone, laptop, tablet computing device, and so on.

The means may be implemented, for example, as an application specific integrated circuit (ASIC) programmed to implement rule based source sequencing for allocation. The means may also be implemented as stored computer executable instructions that are presented to computer 415 as data 410 that are temporarily stored in memory 435 and then executed by processor 420.

The logic of the data management module 165, the analysis module 170, and the transmission control module 185 may also provide means (e.g., hardware, non-transitory computer-readable medium 405 that stores executable instructions, firmware) for performing rule based source sequencing for allocation.

Generally describing an example configuration of the computer 415, the processor 420 may be a variety of various processors including dual microprocessor and other multi-processor architectures. The memory 435 may include volatile memory and/or non-volatile memory. Non-volatile memory may include, for example, read-only memory (ROM), programmable read-only memory (PROM), and so on. Volatile memory may include, for example, random access memory (RAM), static random-access memory (SRAM), dynamic random access memory (DRAM), and so on.

The disks 455 may be operably connected to the computer 415 via, for example, the I/O interface 440 (e.g., card, device) and the I/O ports 445. The disks 455 may be, for example, a magnetic disk drive, a solid state disk drive, a floppy disk drive, a tape drive, a Zip drive, a flash memory card, a memory stick, and so on. Furthermore, the disks 455 may be a CD-ROM drive, a CD-R drive, a CD-RW drive, a DVD ROM, and so on. The memory 435 can store a process, such as within the non-transitory computer-readable medium 405, and/or data 410, for example. The disk 455 and/or the memory 435 can store an operating system that controls and allocates resources of the computer 415.

The computer 415 may interact with input/output (I/O) devices via the I/O interfaces 440 and the I/O ports 445. The I/O devices may be, for example, a keyboard, a microphone, a pointing and selection device, cameras, video cards, displays, the disks 455, the network devices 450, and so on. The I/O ports 445 may include, for example, serial ports, parallel ports, and USB ports. I/O controllers 430 may connect the I/O interfaces 440 to the bus 425.

The computer 415 can operate in a network environment and thus may be connected to the network devices 450 via the I/O interfaces 440, and/or the I/O ports 445. Through the network devices 450, the computer 415 may interact with a network. Through the network, the computer 415 may be logically connected to remote computers (e.g., the computer 415 may reside within a distributed computing environment to which clients may connect). Networks with which the computer 415 may interact include, but are not limited to, a local area network (LAN), a new area network (WAN), and other networks.

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure” or “data object”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on system conditions or specifications. For example, if greater speed is a consideration, then hardware would be selected to implement functions. If a lower computing cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons who consume energy from a utility, computers or other devices operated by or on behalf of such persons, or combinations thereof.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A non-transitory computer-readable medium storing computer-executable instructions that when executed by at least one processor of a computing system cause the at least one processor to:
input a training set of data to a machine learning predictive model, wherein the training set of data includes data records from a plurality of known dwellings, wherein a data record for a corresponding dwelling includes at least (i) a load data of power consumed by the corresponding dwelling over a time period, and (ii) a participation value that indicates that the corresponding dwelling is a known participant in energy reduction settings or is a known non-participant in the energy reduction settings;
generate, by the processor, a feature vector for each of the data records from the training set of data;
wherein the feature vector for a corresponding dwelling represents at least (i) a load shape representing the load data of the corresponding dwelling, and (ii) a dwelling characteristic of the corresponding dwelling;
assign, by the processor, a binary label to each of the feature vectors indicating whether the corresponding feature vector represents a known participant in the energy reduction settings or a known non-participant;
train the machine learning predictive model based at least in part on the feature vectors of the known dwellings to classify target dwellings into (i) a class of dwellings that are likely to participate in implementing the energy reduction settings, or (ii) a class of dwellings that are unlikely to participate in implementing the energy reduction settings;
in response to a request to predict a propensity to implement the energy reduction settings for a target group of dwellings that are known to be non-participants in implementing the energy reduction settings:
generate an empirical load shape for each given target dwelling based on load data from the given target dwelling;
generate, by the processor, a target feature vector for each given target dwelling based on at least the empirical load shape;
apply the machine learning predictive model to the target feature vectors of the target group of dwellings to identify a set of non-participants that are likely to implement the energy reduction settings, comprising:
(i) input the target feature vector of each given target dwelling into the machine learning predictive model; and
(ii) generate, by the machine learning predictive model, a predicted propensity to participate in implementing the energy reduction settings for each given target dwelling based on a classification of at least the target feature vector including the empirical load shape to one or more load shapes in the training set of data;
generate an electronic message including information about implementing the energy reduction settings; and
control, by the processor, a transmission of the electronic message to an electronic address associated with one or more of the target dwellings who are likely to participate based on the predicted propensity.

2. The non-transitory computer-readable medium of claim 1, wherein the machine learning predictive model is a binary classifier, and wherein the binary classifier is configured to, based at least on the target feature vector of the target dwelling:
classify the target dwelling into a class of dwellings that are likely to participate in implementing the energy reduction settings; or
classify the target dwelling into a class of dwellings that are unlikely to participate in implementing the energy reduction settings.

3. The non-transitory computer-readable medium of claim 1, wherein the machine learning predictive model is a binary classifier configured with a logistic regression model that classifies the target dwelling as likely to participate or unlikely to participate in implementing the energy reduction settings.

4. The non-transitory computer-readable medium of claim 1, wherein the load data of the given target dwelling comprises a total power consumed by the given target dwelling over a selected time period, and the empirical load shape represents a pattern of total power consumed by the given target dwelling on a daily basis.

5. The non-transitory computer-readable medium of claim 1, wherein the load shape used to generate the feature vector for each of the data records from the training set of data is an empirical load shape of the corresponding dwelling.

6. The non-transitory computer-readable medium of claim 1, wherein the load shape used to generate the feature vector for each of the data records from the training set of data is an established load shape that replaces an empirical load shape of the corresponding dwelling.

7. The non-transitory computer-readable medium of claim 1, further comprising instructions that when executed by at the at least one processor cause the at least one processor to:
train the machine learning predictive model to generate the predicted propensity to participate based at least in part on empirical load shapes from the plurality of known dwellings.

8. A computing system, comprising:
at least one processor connected to at least one memory;
a non-transitory computer readable medium and including instructions that when executed by the at least one processor cause the computing system to:
obtain, from a database, data records including load data for a target group of dwellings;
wherein the load data for a given target dwelling is indicative of electricity consumed by the given target dwelling over a specified period of time;
generate, by the processor, an empirical load shape for each given target dwelling based on load data from the given target dwelling;
generate, by the processor, a target feature vector for each given target dwelling using at least the empirical load shape corresponding to the given target dwelling;
execute a machine learning predictive model on the target feature vectors of the target group of dwellings to identify a set of target dwellings that are likely to reduce the electricity consumed in accordance with electricity settings, wherein the machine learning predictive model is configured to:
(i) receive as input the target feature vector of each given target dwelling into the machine learning predictive model; and
(ii) generate, by the machine learning predictive model, a predicted propensity to implement the electricity settings for each given target dwelling based on a classification of at least the target feature vector including the empirical load shape to one or more load shapes in the machine learning predictive model that are associated with reducing electricity based on the electricity settings;
generate an electronic message including the electricity settings; and
control, by the processor, a transmission of the electronic message to an electronic address associated with one or more of the target dwellings who are likely to implement the electricity settings based on the predicted propensity.

9. The computing system of claim 8, wherein computing system is configured to generate the target feature vector for each given target dwelling using:
(i) at least the empirical load shape corresponding to the given target dwelling; and
(ii) one or more dwelling characteristics of the given target dwelling.

10. The computing system of claim 8, wherein the machine learning predictive model is a binary classifier configured with a logistic regression model that classifies the target dwellings as either:
(i) likely to participate in implementing the electricity settings; or
(ii) unlikely to participate in implementing the electricity settings.

11. The computing system of claim 8, wherein the electricity settings include adjustments to heating or cooling settings on a temperature control device.

12. The computing system of claim 8, wherein the load data of the given target dwelling comprises a total power consumed by the given target dwelling over a selected time period, and the empirical load shape represents a pattern of total power consumed by the given target dwelling on a daily basis.

13. The computing system of claim 8, wherein the computing system is configured to train the machine learning predictive model based on at least feature vector generated for each dwelling from a plurality of known dwellings;
wherein the feature vectors are generated based on at least a load shape and a dwelling characteristic from the plurality of known dwellings that include:
(i) known participants that have implemented energy reduction settings, and
(ii) known non-participants that have not implemented energy reduction settings.

14. The computing system of claim 8, wherein the computing system is configured to train the machine learning model predictive model based on at least load shapes from a plurality of known dwellings;
wherein a load shape of a given dwelling is replaced by one established load shape from a set of defined established load shapes that closely matches the load shape;
wherein the set of defined established load shapes represent N common archetypal patterns from daily energy usage patterns.

15. The computing system of claim 8, wherein the computing system is configured to train the machine learning predictive model to generate the predicted propensity to implement the electricity settings based at least in part on empirical load shapes from a plurality of known dwellings that are known participants in implementing energy reduction settings and known non-participants that do not implement the energy reduction settings.

16. A computer-implemented method performed by a computing system, the method comprising:
obtaining, from a database, data records including load data for a target group of dwellings;
wherein the load data for a given target dwelling is indicative of electricity consumed by the given target dwelling over a specified period of time;
generating, by the processor, an empirical load shape for each given target dwelling based on load data from the given target dwelling;
generating, by the processor, a target feature vector for each given target dwelling based on at least the empirical load shape corresponding to the given target dwelling;
executing a machine learning predictive model on the target feature vectors of the target group of dwellings to identify a set of target dwellings that are likely to reduce the electricity consumed in accordance with electricity settings, comprising:
(i) inputting the target feature vector of each given target dwelling into the machine learning predictive model; and
(ii) generating, by the machine learning predictive model, a predicted propensity to implement the electricity settings for each given target dwelling based on a classification of at least the target feature vector including the empirical load shape to one or more load shapes in the machine learning predictive model that are associated with reducing electricity based on the electricity settings; and
generating an electronic message including instructions to cause adjustments to temperature settings on a temperature control device.

17. The computer-implemented method of claim 16, wherein generating the target feature vector for each given target dwelling is based on using:
(i) at least the empirical load shape corresponding to the given target dwelling; and
(ii) one or more dwelling characteristics of the given target dwelling.

18. The computer-implemented method of claim 16, wherein the machine learning predictive model is trained based on a data set of known dwellings, wherein a load shape of a known dwelling is replaced by one established load shape from a set of defined established load shapes that closely matches the load shape; and
wherein the set of defined established load shapes represent N categories of archetypal patterns from daily energy usage patterns.

19. The computer-implemented method of claim 16, wherein the machine learning predictive model generates the predicted propensity to implement the electricity settings as a value within a numerical range between a least likely value and a most likely value.

20. The computer-implemented method of claim 16, further comprising:
training the machine learning predictive model based on at least feature vectors generated for each dwelling from a plurality of known dwellings;
wherein the feature vectors are generated based on at least a load shape and a dwelling characteristic from the plurality of known dwellings that include:
(i) known participants that have implemented energy reduction settings, and
(ii) known non-participants that have not implemented the energy reduction settings.
